(19) United States
(12) Patent Application Publication
(10) Pub. No.: US 2004/0088422 A1
(43) Pub. Date: May 6, 2004

(54) Computer network architecture and method relating to selective resource access

(76) Inventors: Thomas J. Flynn, Magnolia, TX (US); Thomas J. Josefy, Houston, TX (US); Gary A. Willett, Katy, TX (US)

Correspondence Address: HEWLETT-PACKARD COMPANY, Intellectual Property Administration, P.O. Box 272400, Fort Collins, CO, 80527-2400, US

(21) Appl. No.: 10/289,095

(22) Filed: Nov. 6, 2002

(51) Int. Cl. G06F 15/16

(52) U.S. Cl. 709/229

(57) ABSTRACT

The disclosed embodiments relate to a computer network architecture and method in which access to computing resources may be selectively controlled. Client-specific computing resources may be identified as unconditionally accessible or conditionally accessible. A condition is associated with the access of each conditionally accessible client-specific computing resource. Access to the conditionally accessible client-specific computing resources is granted if the condition associated with the resource is met.

### BACKGROUND OF THE RELATED ART

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Since the introduction of the first personal computer (“PC”) over 20 years ago, technological advances to make PCs more useful have continued at an amazing rate. Microprocessors that control PCs have become faster and faster, with operational speeds eclipsing a gigahertz (one billion operations per second) and continuing well beyond.

Productivity has also increased tremendously because of the explosion in the development of software applications. In the early days of the PC, people who could write their own programs were practically the only ones who could make productive use of their computers. Today, there are thousands and thousands of software applications ranging from games to word processors and from voice recognition to web browsers.

a. The Evolution of Networked Computing

In addition to improvements in PC hardware and software generally, the technology for making computers more useful by allowing users to connect PCs together and share resources between them has also seen rapid growth in recent years. This technology is generally referred to as “networking.” In a networked computing environment, PCs belonging to many users are connected together so that they may communicate with each other. In this way, users can share access to each other's files and other resources, such as printers. Networked computing also allows users to share internet connections, resulting in significant cost savings. Networked computing has revolutionized the way in which business is conducted across the world.

Not surprisingly, the evolution of networked computing has presented technologists with some challenging obstacles along the way. One obstacle is connecting computers that use different operating systems (“OSes”) and making them communicate efficiently with each other. Each different OS (or even variations of the same OS from the same company) has its own idiosyncrasies of operation and configuration. The interconnection of computers running different OSes presents significant ongoing issues that make day-to-day management of a computer network challenging.

Another significant challenge presented by the evolution of computer networking is the sheer scope of modern computer networks. At one end of the spectrum, a small business or home network may include a few client computers connected to a common server which may provide a shared printer and/or a shared internet connection. On the other end of the spectrum, a global company's network environment may require interconnection of hundreds or even thousands of computers across large buildings, a campus environment, or even between groups of computers in different cities and countries. Such a configuration would typically include a large number of servers, each connected to numerous client computers.

Further, the arrangements of servers and clients in a larger network environment could be connected in any of a large number of topologies that may include local area networks (“LANs”), wide area networks (“WANs”) and municipal area networks (“MANs”). In these larger networks, a problem with any one server computer (for example, a failed hard drive, corrupted system software, failed network interface card or OS lock-up to name just a few) has the potential to interrupt the work of a large number of workers who depend on network resources to get their jobs done efficiently. Needless to say, companies devote considerable time and effort to keep their networks operating trouble-free to maximize productivity.

b. The Development of Thin Client Computing

Networks are typically populated with servers and client computers. Servers are generally more powerful computers that provide common functions such as file sharing and Internet access to the client computers. Traditionally, client computers have themselves been fully functional computers, each having a processor, hard drive, CD ROM drive, floppy drive, and system memory.

Recently, thin client computing devices have begun to appear. Thin client computing devices are generally capable of only the most basic functionality. Many thin client computers do not have their own hard drives, CD ROM drives, or floppy drives. Thin client computers may typically be connected to a network to boot an operating system or load application programs such as word processors or Internet browsers. Additionally, thin clients may have only a relatively small amount of system memory and may have a relatively slow processor compared to fully functional client computer workstations.

What thin clients lack in computing power, however, they make up for in other areas such as reliability. Thin clients may typically be more reliable than their fully functional counterparts because thin clients typically may have fewer parts. For example, many thin clients do not have their own hard drive. Because the hard drive is one of the most likely computer components to fail, the lack of a hard drive may account for a significant increase in the reliability of a thin client computer compared to a fully functional computer with its own hard drive.

The high reliability of thin clients makes them potentially desirable for use in a networked environment. Network maintenance costs are a significant expense in large network environments and companies and other organizations spend a large amount of resources to reduce those costs. Thin clients have the potential to reduce networking costs because of their relative simplicity and increased reliability with respect to fully functional client computers.

In a typical thin client networked environment, thin clients may be connected to a centralized server. The thin client computer may typically communicate with the server through a multi-user terminal server application program. The centralized server may be responsible for providing an operating system for the thin clients that are connected to it. Additionally, the centralized server may supply application programs such as word processing and Internet browsing to the thin clients as needed. The user's data, such as document files, spreadsheets, and Internet favorites, may be stored on the centralized server as well. Thus, when a thin client breaks, it may be removed and replaced without the need to transfer the user's programs to the replacement unit.

Nonetheless, the lack of computing power of some thin clients may have slowed their acceptance rate among network administrators. This slow acceptance may be partially true because of the methods of distributing computing power from the centralized server to thin client computers utilized. Problems may arise when a user of a thin client connected to a central server through a multi-user terminal server application begins the execution of a process that requires a relatively large amount of computing power. If the centralized server does not unable to distribute the computing load effectively, then other thin client users connected to the centralized server through the terminal server application may experience performance problems because of the portion of the power of the centralized server is being diverted to process the needs of a single user.

c. User-Created Problems and “Stickiness”

A problem with network computing is that users of client computer systems sometimes introduce unintended problems into a network environment, especially if users have access to fully functional client computers (e.g. not thin client computers). Computer viruses may invade the network if a user is not utilizing virus protection software or if the user has virus protection software that is disabled, incorrectly installed or configured. Users may create problems for network administrators by using CD-ROM or floppy drives to load software programs that are not compatible with or harmful to the network environment. Problems such as these, while unintended, may result in a significant expense in both time and money for network professionals to fix. Additionally, users may download harmful or otherwise objectionable material from the Internet if access to websites containing that content is permitted.

A separate, yet related, issue is the concept of “stickiness.” Stickiness is a term that refers to the degree to which a user is likely to remain on a given website. A high level of stickiness is sought by advertisers and providers of content. Compelling content may make a website more sticky. In other words, users are likely to stay on the website because they like what they see or have a great need for the information provided. Stickiness may also be thought of as the degree to which a user will continue to use a given set of resources such as software applications. A network architecture that reduces the opportunity for users to inject problems into the network environment while promoting increased stickiness is desirable.

### BRIEF DESCRIPTION OF THE DRAWINGS

The foregoing and other advantages of the invention will become apparent upon reading the following detailed description and upon reference to the drawings in which:

FIG. 1 is a block diagram of a client-server computer network architecture;

FIG. 2 is a block diagram of an example of a network architecture according to embodiments of the present invention;

FIG. 3 is a functional block diagram that is useful in explaining the operation of network architecture according to the embodiments of present invention; and

FIG. 4 is a process flow diagram according to embodiments of the present invention.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

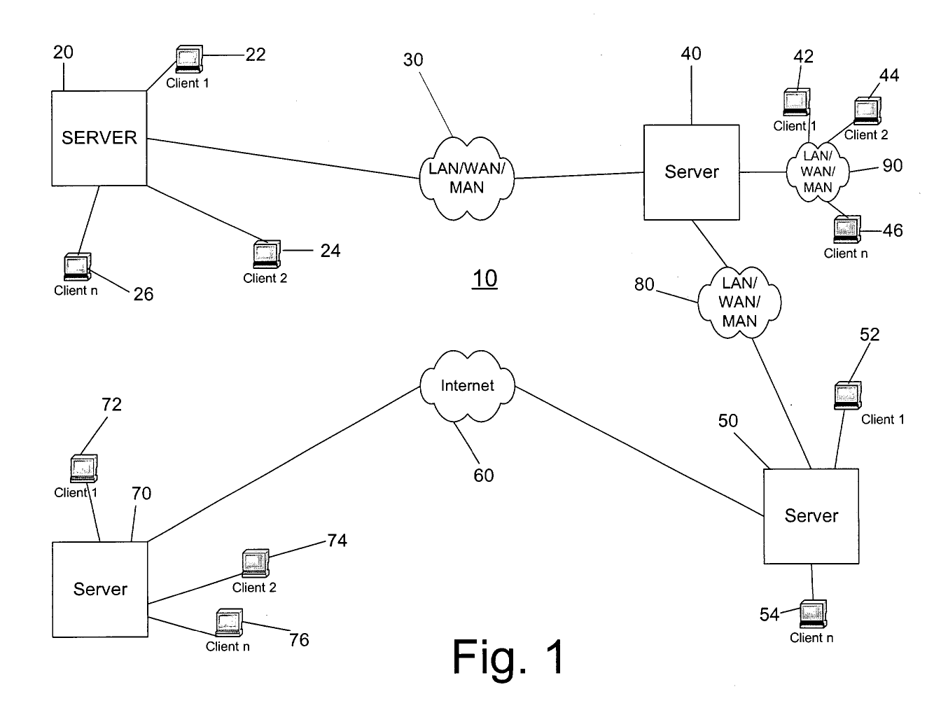

Turning now to the drawings and referring initially to FIG. 1, a block diagram of a computer network architecture is illustrated and designated using a reference numeral 10. A server 20 is connected to a plurality of client computers 22, 24 and 26.

The server 20 may be connected to as many as n different client computers. Each client computer in the network 10 may be a fully functional client computer. The magnitude of n may be a function of the computing power of the server 20. If the server 20 has large computing power (for example, faster processor(s) and/or more system memory), it may be able to effectively serve a large number of client computers.

The server 20 is connected via a network infrastructure 30, which may include any combination of hubs, switches, routers, and the like. While the network infrastructure 30 is illustrated as being either a local area network (“LAN”), a wide area network (“WAN”) or a municipal area network (“MAN”), those skilled in the art will appreciate that the network infrastructure 30 may assume other forms or may even provide network connectivity through the Internet. As will be described, the network 10 may include other servers, which may be widely dispersed geographically with respect to the server 20 and to each other to support client computers in other locations.

The network infrastructure 30 connects the server 20 to server 40, which may be representative of any other server in the network environment of server 20. The server 40 may be connected to a plurality of client computers 42, 44, and 46. As illustrated in FIG. 1, a network infrastructure 90, which may include a LAN, a WAN, a MAN or other network configuration, may be used to connect the client computers 42, 44 and 46 to the server 40. The server 40 is additionally connected to server 50, which is in turn connected to client computers 52 and 54. A network infrastructure 800, which may include a LAN, a WAN, a MAN or other network configuration, may be used to connect the client computers 52, 54 to the server 50. The number of client computers connected to the servers 40 and 50 may be dependent on the computing power of the servers 40 and 50, respectively.

The server 50 may additionally be connected to the Internet 60, which may in turn be connected to a server 70. The server 70 may be connected to a plurality of client computers 72, 74 and 76. The server 70 may be connected to as many client computers as its computing power will allow.

Those of ordinary skill in the art will appreciate that the servers 20, 40, 50, and 70 may not centrally located. A network architecture, such as the network architecture 10, may typically result in a wide geographic distribution of computing resources that must be maintained. The servers 20, 40, 50, and 70 must be maintained separately. Also, the client computers illustrated in the network 10 are subject to maintenance because each may itself be a fully functional computer that stores software and configuration settings on a hard drive or elsewhere in memory. In addition, many of the client computers connected with the network 10 may have their own CD-ROM and floppy drives, which may be used to load additional software. The software stored on the fully functional clients in the network 10 may be subject to damage or misconfiguration by users. Additionally, the software loaded by users of the client computers may itself need to be maintained and upgraded from time to time.

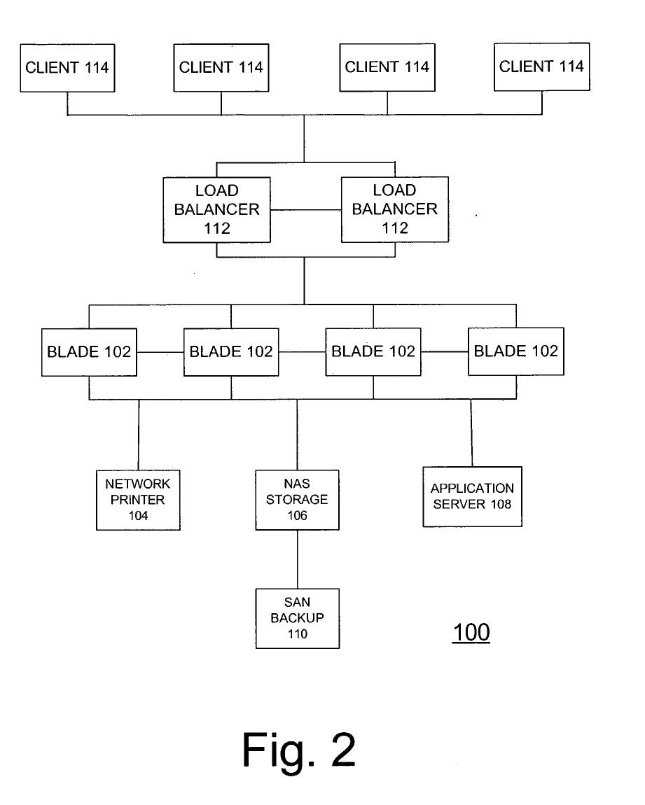

FIG. 2 is a block diagram of an example of a network architecture in accordance with embodiments of the invention. The network architecture is referred to generally by the reference numeral 100.

A plurality of server blades 102 are connected together to form a centralized computing engine. A server blade may include many components of a server on a printed circuit board, which may be referred to as a blade. Examples of components that may be included on a server blade may include a network interfaces, a CPU, system memory and/or a hard disk. Server blades may be installed by plugging them into an enclosure, such as a cabinet or chassis. It may be possible to include more server blades in the space previously occupied by non-blade servers. In addition, server blades may provide additional computing power while reducing power consumption, cooling requirements and/or cabling complexity. Power and networking connections may be provided by server blade backplanes into which multiple server blades may be plugged.

Four server blades are shown in the network architecture 100 for purposes of illustration, but server blades may be added to or removed from the computing engine as needed. The server blades 102 may be connected by a network infrastructure so that they may share information. PCI-X, Infiniband or any other suitable network infrastructure may be examples of network infrastructures that may be employed to interconnect the server blades 102 together.

The server blades 102 may be connected to additional computing resources, such as a network printer 104, a network attached storage (“NAS”) device 106, and/or an application server 108. NAS devices, such as the NAS device 106, may be specialized file serving devices that provide support for heterogeneous files in a high capacity package. NAS may also provide specific features to simplify the tasks and reduce the resources associated with data storage and management. A NAS solution may work with a mix of clients and servers running different operating systems.

The NAS device 106 may be connected to a back-up device such as a storage attached network (“SAN”) back-up device 110. A SAN may be a storage architecture in which storage devices may be connected together on an independent network with respect to servers and client computers. SANs may be used to provide back-up capability in a NAS storage environment.

The server blades 102 may additionally be connected to a plurality of load balancers 112. For purposes of illustration, two load balancers 112 are shown. Additional load balancers may be added to facilitate handling of larger amounts of network traffic or other reasons. The load balancers 112 may comprise load balancing switches or routers, or any other device that may distribute the computing load of the network among the plurality of server blades 102. The load balancers 112 may be connected to a plurality of client computers 114 and are adapted to receive network traffic, including requests to perform computing services, such as to perform computing tasks or store or print data. While four client computers are illustrated, a lesser or greater number may be employed.

The load balancers 112 may distribute requests among the server blades 102 according to any protocol or scheme. Examples of distribution schemes that may be used are round-robin distribution or use-based distribution schemes. In a round-robin distribution scheme, no consideration is taken for whether the server blade requested to perform a task is under-utilized or over-utilized. Instead, requests are simply passed to the server blades in a predetermined. In a use-based distribution scheme, the load balancers 112 may have the capability to communicate with the server blades 102 to determine the relative workload being performed by each of the server blades 102. Requests for additional work may be forwarded to a server blade that may service the request.

The client computers 114 may comprise thin client computer systems. The load balancers 112 may be connected to the client computers through a single-user terminal server program such as the single-user terminal server utility that is provided as part of the Microsoft Windows XP operating system, which is available from Microsoft Corporation of Redmond, Wash. Other single-user terminal server applications may be used, as well.

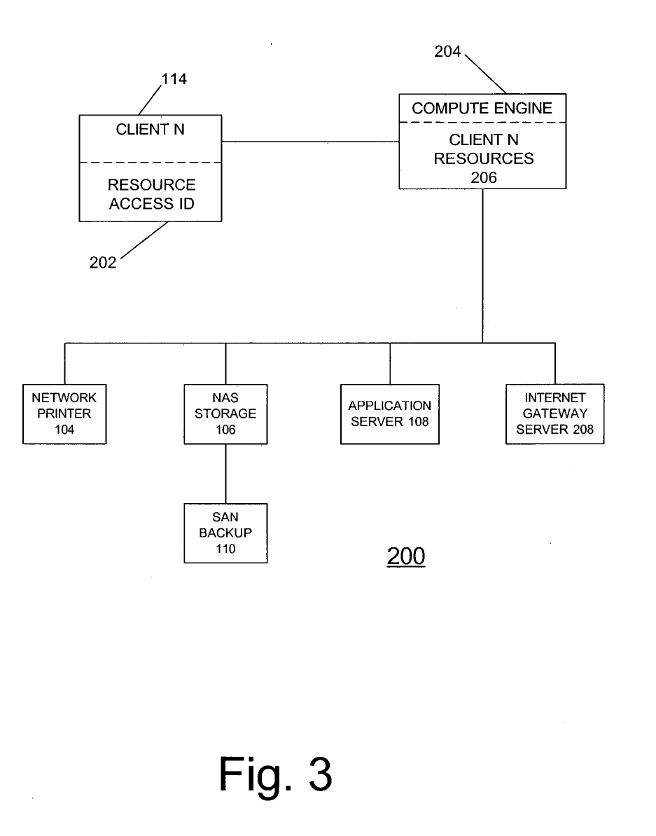

FIG. 3 is a functional block diagram that is useful in explaining the operation of an exemplary network architecture according to the embodiments of present invention. A network environment 200 depicted in FIG. 3 shows how the network architecture 100 (FIG. 2) may be employed to promote sticky access to network resources. For simplicity, the connections involving the load balancers 112 are omitted.

The nature of thin client computer systems allows them to be deployed in a network architecture (such as the network architecture 100 (FIG. 2)) to prohibit users from introducing unintended problems into the computing environment while promoting stickiness. If the client computer 114 is a thin client computer without a CD ROM drive, a floppy drive or a hard drive, it may be difficult for a user to load software that may be incompatible with the network environment or that may contain a virus into the operating environment of the network of which the client n 114 is a member.

The lack of storage resources on the client n 114 may also mean that the user of the client n 114 must rely on an external source such as a computing engine 204 for computing resources such as access to an operating system, application programs, internet access or access to other system resources such as the network printer 104, the NAS storage device 106, the SAN back-up device 110, the application server 108, an internet gateway 208 or the like. Some of the computing resources may be unconditionally available to the client n 114 (available all the time) while other computing resources may be conditionally available when certain predetermined conditions are met.

The computing engine 204 is representative of the computing power of the server blades 102 (FIG. 2). Access to resources may be controlled at the computing engine 204. Stickiness may be promoted because the user may not have access to resources associated with the computing engine other than the resources allocated to the client n 114.

The client n 114 may include a resource access identifier 202. The resource access identifier 202 may take the form of a list of resources that may be either conditionally or unconditionally available to the client n 114. The resource access identifier 202 may be stored on the client n 114. Alternatively, a resource list 206 may be maintained on the computing engine 204. The resource list 206 may include whether the client-specific computing resources are either conditionally or unconditionally available to the client n 114. The client n 114 may be identified to the computing engine 204 through a login account or any other means of associating the specific client n 114 with the associated list of accessible resources 206. The list of resources that are accessible to the client n 114 may be maintained and associated with the client n 114 by the computing engine 204 by any conventional means.

The ability to control which computing resources are available to the client n 114 may facilitate sticky access to the client-specific computing resources. For example, the computing engine 204 may permit a user of the client n 114 to access only certain operating system features that are authorized for that user. This may be possible because the user of the client n 114 may receive the operating system from the computing engine 204. Also, access to software applications may be strictly controlled. A user may be given access to certain productivity software such as word processing or spreadsheet software while being denied access to other software such as computer games or the like.

The network architecture 200 may have additional commercial applications. An application service provider company may provide access to various software programs for a limited time period. For example, a business user may purchase access to a program needed to prepare a presentation while on a business trip or the like. In this example, the application program purchased or leased by the user may be a conditionally accessible computing resource. The payment of the requisite fee may be a predetermined condition for access to the computing resource. After a predetermined time period, access to the program may be denied by the computing engine 204 unless the user pays for additional access.

Similarly, the computing engine 204 may be used to restrict a user's web access so that the user's access is sticky, or limited to specific web sites or types of Internet services. Access to certain web sites may be permitted while access to other sites may be denied. In a business context, this may mean that business users could be permitted access to web sites that facilitate productivity while being denied access to web sites that detract from productivity.

In the context of private web access, an internet service provider could use the network architecture 200 to limit access of customers to web sites to which the customer has paid for access. For example, an internet service provider may permit access only to its own website (or a specific group of web sites) for a basic fee and charge additional fees for allowing access to other Internet resources such as Internet chatting, news groups or web hosting services. Clients of these services may be unable to upload potentially problematic software or viruses because their thin client computer systems may not have the ability to load software. Additionally, customers of the Internet service provider may benefit from having thin client computers, with their attendant reliability relative to fully functional computers.

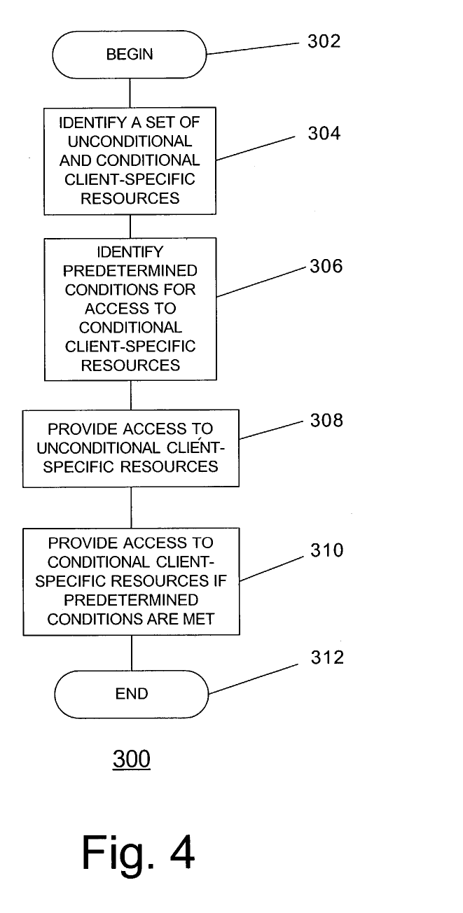

FIG. 4 is a process flow diagram illustrating the operation of embodiments of the present invention. The process is generally referred to by the reference numeral 300. At block 302, the process begins.

At block 304, a set of client-specific resources is identified. Client-specific resources may include operating system features, application programs, access to web sites, services, system resources or any combination thereof. Additionally, client-specific resources may be accessible either conditionally or unconditionally. Unconditionally accessible client-specific resources may be accessed by a user of the client computer at any time. Conditionally accessible client-specific resources may be accessed by the user only when predetermined conditions are met. For example, certain client-specific resources may be conditionally accessible only during time periods for which the user has paid a fee. The predetermined conditions for access to conditionally accessible client-specific resources are identified, as shown at block 306.

At block 308, the user is provided with access to the client-specific resources that are unconditionally accessible. As shown at block 310, access to conditionally accessible client-specific resources is permitted only if the predetermined conditions (identified at block 306) corresponding to the predetermined conditions are met. The user may be denied access to resources that are not identified as client-specific resources. Also, the user may be denied access to conditionally accessible client-specific resources unless the specified predetermined conditions are met. At block 312, the process ends.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of operating a computer network to provide selective access to network resources, the method comprising:
identifying a set of client-specific computing resources associated with a client computing system, a first portion of the set of client-specific computing resources being unconditionally accessible by the client computing system and a second portion of the set of client-specific computing resources being conditionally accessible by the client computing system;
identifying a condition for granting access to each of the conditionally accessible computing resources;
providing the client computing system with access to the unconditionally accessible computing resources; and
providing the client computing system with access to each of the conditionally accessible computing resources if the condition for granting access is met.

2. The method of claim 1, wherein identifying a set of client-specific computing resources associated with a client computing system includes identifying the client specific resources associated with a thin client computing system.

3. The method of claim 1, comprising identifying access to an operating system as one of the unconditionally accessible computing resources.

4. The method of claim 1, comprising identifying access to an application program as one of the conditionally accessible computing resources.

5. The method of claim 4, comprising identifying access to a word processing program.

6. The method of claim 1, wherein identifying a condition for granting access to the conditionally accessible computing resources includes identifying payment of a fee.

7. The method of claim 1, wherein identifying a condition for granting access to the conditionally accessible computing resources comprises identifying access to the Internet.

8. The method of claim 1, comprising identifying access to an application server as one of the conditionally accessible computing resources.

9. The method of claim 1, wherein the recited acts are provided in the recited order.

10. A computer network architecture that provides selective access to network resources, comprising:
a plurality of client computing devices, each of which is adapted to generate requests for computing services, each of the client computing devices having associated therewith a set of client-specific computing resources, a first portion of the set of client-specific computing resources being unconditionally accessible by the associated client computing device and a second portion of the set of client-specific computing resources being conditionally accessible by the associated client computing device if a condition is met;
a load balancing resource adapted to receive the requests for computing services and use a distribution scheme to direct the requests for computing services for further processing by available resources;
a computing resource adapted to receive and process selected requests for computing services from the load balancing resource, the computing resource being adapted to provide the plurality of client computing devices with access to the unconditionally accessible computing resources associated therewith and to provide the plurality of client computing devices with access to the conditionally accessible computing resources associated therewith if the predetermined condition is met.

11. The computer network architecture of claim 10, comprising a data resource coupled to the computing resource to process certain of the selected requests for computing services.

12. The computer network architecture of claim 10 wherein at least one of the client computing devices comprises a thin client computing device.

13. The computer network architecture of claim 10 wherein at least one of the client computing devices is adapted to connect to the load balancing resource through a single-user terminal server application.

14. The computer network architecture of claim 10 wherein the computing resource comprises a plurality of server blades.

15. The computer network architecture of claim 10, wherein at least one of the unconditionally accessible computing resources comprises an operating system.

16. The computer network architecture of claim 14, wherein at least one of the conditionally accessible computing resources comprises an application program.

17. The computer network architecture of claim 16, wherein the application program comprises a word processing program.

18. The computer network architecture of claim 10, wherein at least one of the conditions for granting access to one of the conditionally accessible computing resources comprises the payment of a fee.

19. The computer network architecture of claim 10, wherein at least one of the conditionally accessible computing resources comprises access to the Internet.

20. A method of providing Internet access, the method comprising:
providing a client computing device;
providing a load balancing resource adapted to receive requests for Internet access from the client computing device and to use a distribution scheme to direct the requests for Internet access for further processing;
receiving the requests for Internet access from the load balancing resource;
in response to the requests for Internet access received from the load balancing resource, providing the client computing device with conditional access to the Internet if a condition is met.

21. The method of claim 20, wherein providing a client computing device includes providing a thin client computing system.

22. The method of claim 20, wherein providing the client computing device with conditional access to the Internet if a condition is met includes providing the client computing device with conditional access to the Internet upon payment of a fee.

23. The method of claim 20, wherein providing the client computing device with conditional access to the Internet if a condition is met includes providing access to a predetermined group of web sites.

24. The method of claim 20, wherein providing the client computing device with conditional access to the Internet if a condition is met includes providing access to at least one web application.

25. The method of claim 20, wherein providing the client computing device with conditional access to the Internet if a condition is met includes providing access to web hosting services.

26. The method of claim 20, wherein the recited acts are provided in the recited order.
